(19) United States
(12) Patent Application Publication
(10) Pub. No.: US 2019/0255565 A1
(43) Pub. Date: Aug. 22, 2019

(54) METAL STRIP WITH TRANSPORTATION PROTECTION

(71) Applicant: Berndorf Band GmbH, Berndorf (AT)

(72) Inventors: Gernot FLORL, Eichgraben (AT); Andreas JANCSIK, Neuhaus (AT)

(73) Assignee: Berndorf Band GmbH, Berndorf (AT)

(21) Appl. No.: 16/346,171

(22) PCT Filed: Nov. 21, 2017
(86) PCT No.: PCT/AT2017/060308

§ 371 Date: Apr. 30, 2019

(30) Foreign Application Priority Data
Nov. 23, 2016 (AT) A 51061/2016

(51) Int. Cl. B05D 7/16; B05D 7/00; B05D 3/02; C09D 5/20; C09D 7/20

(52) U.S. Cl. CPC B05D 7/16; B05D 7/544; C09D 7/20; C09D 5/20; B05D 3/0254

(57) ABSTRACT

The invention relates to a method for provision of a metal strip (1) with a protection for transportation, wherein the metal strip (1), in a Step i), is coated with a plastic, and, in a Step ii), is wound up in multiple layers, wherein in Step i), the plastic is applied to the metal strip in liquid or paste form, and solidified, wherein in Step i), a strippable varnish based on an organic solvent is applied as a plastic.

The invention relates to a method for provision of a metal strip with a protection for transportation, wherein the metal strip, in a Step i), is coated with a plastic, and in a Step ii), is wound up in multiple layers, wherein in Step i), the plastic is applied to the metal strip in liquid or paste form, and solidified.

Furthermore, the invention relates to a metal strip.

Metal strips are produced with very high surface quality for specific purposes of use, and are ground, for example, or actually polished to a high shine. Such metal strips are used for the production of panel-shaped or film-type materials, for example, in particular for films for photography, LCD screens or, alternatively, for artificial stone (“Engineered Stone”). In this regard, a liquid or paste material is applied to a driven/moving belt, and the at least partially solidified material is lifted off from it. The surface quality of the product produced using such a metal strip is directly dependent on the surface quality of the metal strip.

The required surface quality of the metal strip can generally be achieved only within the scope of production of the factory type, thereby resulting in the requirement that the finished metal strip must be transported to the later place of use as free of damage as possible. For this purpose, the metal strip according to the state of the art is covered with a self-adhesive plastic film that protects the metal strip against scratches, and, to a certain degree, also against the penetration of sharp objects, on its transportation path. At the place of use, this plastic film is pulled off again.

A disadvantage of this method is that an adhesive film generally cannot be pulled off without residues. Even if adhesive residues are no longer visible on the metal strip with the naked eye, they can nevertheless be detected on the metal surface. Since even these minimal contaminants disrupt the subsequent production process in which the metal strip is used, (e.g. production of panel-shaped or film-type materials), the metal strip must be cleaned, which requires effort. Due to the high surface quality, this is only possible using special means, since even wiping with a soft cloth or “rubbing off” adhesive residues can already impair the surface quality of the metal strip. The use of solvents is generally eliminated, since these generally also cause undesirable residues on the metal strip.

For this reason, it has become known from AT 514126 A1, to overcome the disadvantages stated above, to apply a coating of silicone rubber or a coating based on water as the solvent, in the form of a plastic film, for protection of the surface of the metal strip, directly to the strip.

However, it has turned out that due to increased quality demands regarding highly polished surfaces and the products produced using them, even the slightest residues are considered to be disruptive. However, in the case of water-based coatings or in the case of silicone rubber, slight residues remaining on the surface of the metal strip can nevertheless occur when the plastic film is pulled off.

It is therefore the task of the invention to overcome the aforementioned disadvantages of the state of the art, and to make it possible to remove a film that serves as protection for transportation, without residues, even in the case of surfaces having the highest quality.

The task stated above is accomplished, according to the invention, with a method of the type stated initially, in that in Step i), a strippable varnish based on an organic solvent is applied as a plastic.

It has surprisingly been found that in the case of strippable varnishes based on organic solvents, no recognizable residues occur on the surface and in products produced on it, for example monitor screens, after the strippable varnish is stripped from the metal strip, even in the case of highly polished surfaces that must meet the highest quality demands, as is the case in the film casting industry, for example.

Aside from the effect that the protective layer can be released from the metal strip without residues, an advantageous cleaning effect also occurs. During coating of the metal strip, it cannot be precluded with one-hundred percent certainty, at reasonable technical effort, that dirt and dust particles adhere to the metal strip, and are subsequently enclosed by the protective layer.

In the case of conventional methods with an adhesive film, this leads to the result, under some circumstances, that these dirt and dust particles adhere to the metal strip comparatively strongly due to adhesive residues, and can be removed only with difficulty. In particular, the cleaning process is made more difficult because any kind of mechanical cleaning (e.g. wiping or brushing) almost inevitably leads to scratching of the metal strip by the dirt and dust particles.

According to the method presented, however, the dirt and dust particles are pulled off together with the protective layer, without any grinding relative movement coming about between the sensitive metal surface and the dirt and dust particles, some of which are very hard, during this action. In particular, it is advantageous if the adhesion force or adhesive force of the protective layer is greater than the electrostatic attraction force of dust particles.

In the end result, when using the protective layer presented, synergies therefore occur, aside from the protection against mechanical damage or against other environmental influences during transport (e.g. corrosion, in particular during transport by sea), in that not only can the protective layer be released from the metal strip again without residues, but rather, the layer also additionally cleans the strip. In general, the metal strip is therefore immediately ready for use after the protective layer has been pulled off.

In order to protect the strippable varnish against mechanical stresses, it can be provided that the strippable varnish applied in Step i) is dried, and in a subsequent step is varnished again with at least one layer of a cover varnish, in particular one based on an organic solvent.

It can be provided that the strippable varnish and the cover varnish are sprayed on; this is particular advantageous with regard to achieving optimal adhesion to the metal surface and so as to achieve the most constant and defined layer thickness possible.

It has proven to be particular advantageous, with regard to avoiding residues, if the strippable varnish applied in Step i) has a solvent proportion between 30 and 60 percent by weight, wherein toluene and/or acetone, in particular, is/are used as a solvent. Furthermore, the strippable varnish applied in Step i) can have a plastic proportion between 30 and 60 percent by weight.

The task stated above can also be accomplished with a metal strip of the type stated initially, according to the invention, in that it is provided with a protection for transportation in accordance with a method according to claims 1 to 5, and has a solvent-based strippable varnish that adheres directly to the metal strip.

According to a variant of the invention, which is particularly suitable for applications that require the most perfect surface possible of the metal strip, for example in the case of TAC film casting methods, it can be provided that the metal strip has a surface polished to a high shine, which surface is coated with the strippable varnish over its full area.

It can be provided that the strippable varnish has a layer thickness between 50 μm and 100 μm; this is particularly advantageous with regard to achieving both good adhesion and good strippability of the strippable varnish.

Furthermore, optimal protection of the surface of the metal strip can be achieved, without impairing the adhesion properties or stripping properties of the protection for transportation, if the metal strip has at least one layer composed of a cover varnish, applied directly to the strippable varnish, wherein a total thickness of a protective layer consisting of strippable varnish and cover varnish amounts to between 100 μm and 200 μm.

It is advantageous if the protective layer composed of strippable varnish and cover varnish can be bent by at least 180° without destroying it. In this manner, it is made possible that the protective layer can be pulled off particularly easily, i.e. or guaranteed that the protective layer is not too brittle, so that it does not already break when lifted slightly, and that the protective layer can no longer be removed in one piece.

For a better understanding of the invention, it will be explained in greater detail using the following figures.

These show, each in a greatly simplified, schematic representation:

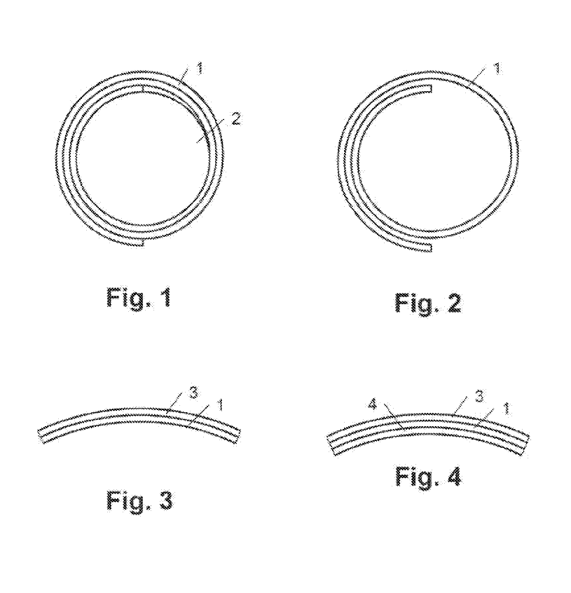

FIG. 1 a metal strip wound onto a core in spiral shape, with layers that lie one on top of the other;

FIG. 2 a metal strip wound up in spiral shape, with layers that are spaced apart from one another;

FIG. 3 a metal strip coated on one side, in a detail view;

FIG. 4 a metal strip coated on both sides, in a detail view;

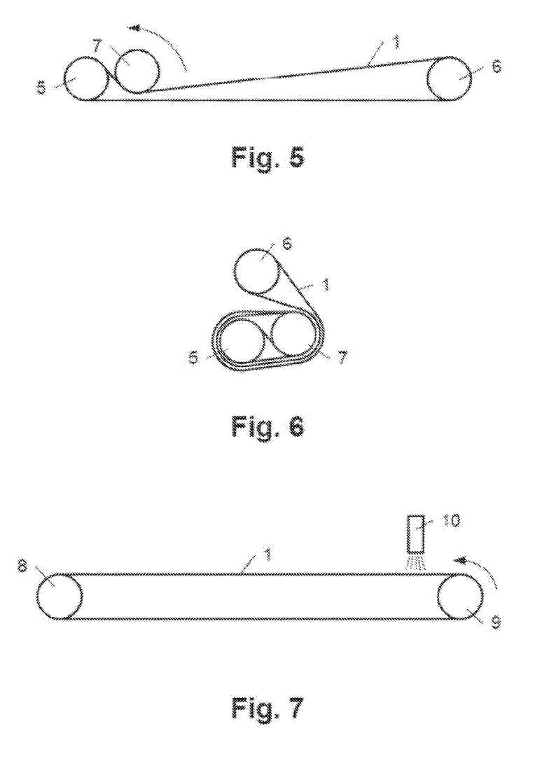

FIG. 5 an endless metal strip before the winding-up process;

FIG. 6 the endless metal strip from FIG. 5 after the winding-up process;

FIG. 7 an exemplary spray device for spraying liquid plastic on;

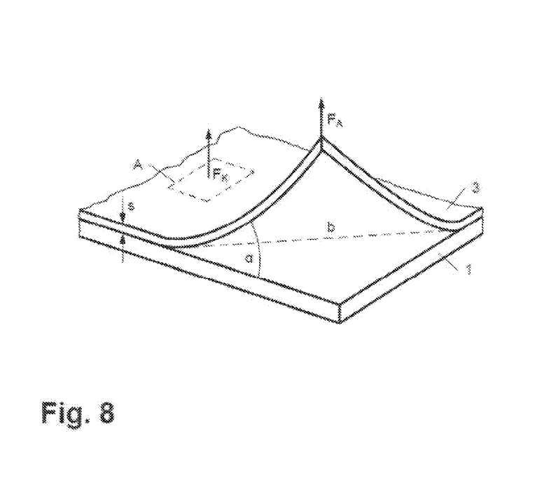

FIG. 8 a schematic representation of a pull-off process of the protective layer.

As an introduction, it should be stated that in the different embodiments described, the same parts are provided with the same reference symbols or the same component designations, wherein disclosures contained in the description as a whole can be applied analogously to the same parts having the same reference symbols or component designations. Also, the position information selected in the description, such as at the top, at the bottom, at the side, etc., for example, relates only to the figure being directly described and shown, and this position information must be applied analogously to a new position in the case of a change in position.

FIG. 1 shows a first possibility for winding up a metal strip 1. In this case, this strip is wound in spiral shape around a core 2, wherein the individual layers lie one on top of the other.

In FIG. 2, the metal strip 1 is also wound in spiral shape, but the individual layers are spaced apart from one another here.

FIG. 3 shows an exemplary protective layer 3, which in this case adheres to the metal strip 1 only on one side.

In FIG. 4, in contrast, a metal strip 1 is shown that is equipped with protective layers 3 and 4 on both sides.

The winding techniques shown in FIGS. 1 and 2 are suitable for winding up/reeling up a finite metal strip 1. In FIGS. 5 and 6, in contrast, a winding technique for winding up an endless metal strip 1 is shown. In this regard, the metal strip is laid around a first and a second core 5 and 6. Now a third core 7 is laid onto the metal strip 1 from the outside. While the first and the third core 5 and 7 are held in place (for example, they can be screwed to one another by way of rails), the second core 6 is moved around the cores 5 and 7 in the direction of the arrow, and thereby the metal strip 1 is wound up. Then an arrangement as shown in FIG. 6 occurs. For stabilization of the resulting composite, the second core 6 can also be screwed to the first and third core 5 and 7 by way of rails.

According to the invention, before the metal strip 1 is wound up or reeled up, it is coated, in a first Step i), with a strippable varnish based on an organic solvent. The liquid strippable varnish can have between 30 and 60 percent by weight organic solvent and between 30 and 60 percent by weight plastic. The plastic can be, for example, polyolefins, for example high-density or low-density polyethylene (PE) or polypropylene (PP). In addition, however, polyvinyl chloride (PVC), polystyrene (PS), various polyesters, as well as polycarbonate (PC) or polyethylene terephthalate (PET) are also suitable. Furthermore, additives can also be added.

After evaporation of the solvent, the strippable varnish forms a plastic layer in the form of a plastic film that adheres in strippable manner, which film can be pulled off the surface of the metal strip 1 in destruction-free manner. Preferably, the layer thickness of the dried strippable varnish on the metal strip 1 amounts to between 50 μm and 100 μm.

FIG. 7 now shows a first possibility, presented schematically, as to how the liquid strippable varnish can be applied to the metal strip 1. In this regard, the metal strip 1 is passed over two rollers 8 and 9 and put into motion, and moved passed a spray device 10 in such a manner that is sprays the liquid strippable varnish onto the metal strip. The spray device 10 is configured as a spray bar that extends over the entire width of the metal strip 1. Furthermore, spraying takes place according to what is called an airless spraying method. Following the spray device 10 in the movement direction of the metal strip, a drying tunnel, not shown here, can be provided, in which the strippable varnish dries.

After drying of the strippable varnish, in a subsequent step, the strippable varnish is varnished again with a layer of a cover varnish, preferably based on an organic solvent. In this regard, the cover varnish, just like the strippable varnish, can be sprayed on using the spray device 10, wherein multiple cover varnish layers can be sprayed on by means of completely passing the metal strip 1 through under the spray bar 10 multiple times.

In FIG. 7, coating on only one side is shown, but of course, the metal strip 1 can also be coated on both sides. For example, for this purpose, a second spray device can be provided for this purpose on the inside of the strip, or the metal strip 1 is turned after the first side has been coated. In place of the spray device, an apparatus for brushing on or rolling on the liquid strippable varnish can also be provided, in equivalent manner.

FIG. 8 shows a further possibility for coating of the metal strip 1. This again is passed over two rollers 8 and 9 and put into motion. In place of a spray device 10, however, an immersion basin 11 with liquid plastic is provided here, through which the metal strip 1 is drawn. Depending on the immersion depth, in this regard, the metal strip 1 can be coated on one side or also on both sides, during one work cycle.

It is furthermore advantageous if the metal strip 1 is coated on its entire length, because in this way, particularly good protection of the same is provided, in particular also protection in the case of slipping of the layers of the wound-up metal strip 1. Particularly preferably, the metal strip 1 has a highly polished surface, which serves as a process surface used for production of a product, and is coated with the strippable varnish over its full area.

In general, the methods shown in FIGS. 7 and 8 are not restricted to coating of an endless metal strip 1. Of course, a finite metal strip 1 can also be coated in this manner, in that it is unwound from a roller, coated, and afterward wound up onto another roller, for example.

After coating, the metal strip 1 is wound up in a subsequent Step ii), for example as shown in FIGS. 5 and 6. As a result, the metal strip 1 is already protected when it is being wound up. Furthermore, in this way the result can be achieved, in relatively simple manner, that the metal strip 1 is covered with a protective layer 3, 4 consisting of strippable varnish and cover layer, over its full area. Checking of the protective layer 3, 4 is also possible in relatively simple manner as a result. Once again, winding up can take place in such a manner that the individual layers lie on top of one another, or in such a manner that they remain at a distance from one another.

If the individual layers of the wound-up metal strip 1 lie on top of one another, then depending on the coating and the winding technique, either a plastic surface and a metal surface make contact with one another, or two plastic surfaces make contact with one another. If the metal strip 1 is coated on one side, for example, as shown in FIG. 3, and wound up as shown in FIG. 1, then a (solidified) plastic layer 3 makes contact with a metal surface. If it is coated on both sides, then a plastic layer 3 makes contact with another plastic layer 4. For the deliberations below, this latter case is assumed.

It is now advantageous if a first adhesion friction coefficient between the metal strip 1 and the protective layer 3 that adheres to it, i.e. between the metal strip 1 and the protective layer 4 that adheres to it, is greater than a second adhesion friction coefficient that characterizes the friction between two solidified boundary layers of the protective layers 3 and 4. This means, in other words, that sliding starts between the protective layers 3 and 4, and not between the metal strip 1 and the protective layer 3 or the protective layer 4. In this way, it is advantageously prevented that foreign bodies on the metal surface, which are enclosed by the protective layer 3 or 4, scratch the metal surface if shifting of the layers of the wound-up body takes place. Also, detachment of the protective layers 3 and 4 is prevented in this manner.

Analogous considerations apply if a protective layer 3 comes to lie on a metal surface 1. In this regard, a distinction must be made between the first boundary surface between metal strip 1 and the protective layer 3, to which the plastic is applied in liquid form, and the second boundary surface between the metal strip 1 and the protective layer 3 that has already solidified. Once again, it is advantageous if the first adhesion friction coefficient at the first boundary surface is greater than a third adhesion friction coefficient at the second boundary surface. This means that sliding is initiated at the second boundary surface, in other words between the solidified plastic layer 3 and metal strip 1, and not between the adhering plastic layer 3 and metal strip 1.

At this point, it should be noted that not only does friction in the traditional sense occur at the boundary surface between metal strip 1 and the adhering protective layer 3, but rather, shear forces are also in effect because of the adhesion, without a normal force being required for this purpose.

In the connection described, it is also particularly advantageous if the solidified plastic layers 3 and 4 are block-resistant. Block resistance refers to a property according to which the layers, once they have solidified, no longer adhere to one another if they are pressed onto one another. In this way, it is guaranteed that the protective layers 3 and/or 4 that have been applied to the metal strip 1 do not adhere to one another when the metal strip 1 is wound up.

It is furthermore advantageous if the solidified plastic layer 3 can be bent upward by at least 180° (see also the angle α in FIG. 8) without destruction, in other words at least normal to the metal surface to which it adheres. In this manner, it is made possible that the protective layer 3 can be pulled of easily, i.e. it is guaranteed that it does not break when removed, as is the case for brittle coatings. In an ideal case, the protective layer 3 can generally be removed in one piece.

In this connection, it is also advantageous if the product of the tensile strength of the solidified plastic and the thickness of the protective layer 3 is greater than its peel resistance, i.e. if the following holds true:

σₜₑₙₛᵢₒₙ·s>σ_{peeling}

FIG. 8 is supposed to make this clear; it shows a piece of the metal strip 1 with a partially pulled-off protective layer 3. The peel resistance is defined by:

$${σ}_{peeling} = \frac{{F}_{A}}{b}$$

wherein F_{A} refers to the force that is required for pulling off the protective layer 3, and b is the length of the pull-off edge on which the force F_{A} acts. The tensile strength is defined as:

$${σ}_{tension} = \frac{{F}_{A}}{b \cdot s}$$

wherein F_{A} refers to the force that acts within the protective layer, b again is the length of the pull-off edge, and s is the thickness of the protective layer. If the above requirement is met, it is made possible for the protective layer 3 to be pulled off easily, in particular in one piece.

It is advantageous if the peel resistance of the protective layer 3 amounts to at least 0.1 N/cm and/or maximally 1 N/cm. In this manner, it is guaranteed that the protective layer 3 can still be pulled off by hand. In this regard, it is furthermore advantageous if the tensile strength of the protective layer 3 amounts to at least 0.1 N/cm², in particular at least 1 N/cm², because in this way it is guaranteed that the protective layer 3 does not tear when it is being pulled off. Furthermore, it is advantageous if the adhesive strength of the protective layer amounts to at least 0.1 N/cm² and/or maximally 1 N/cm² (see, in this regard, the adhesive strength or adhesion strength F_{K} with reference to the surface area A in FIG. 8). In this manner, it is guaranteed that the protective layer 3 adheres sufficiently for transport, but can still be pulled off by hand. It is also advantageous if the layer thickness s of the protective layer 3 consisting of strippable varnish and cover varnish amounts to at least 100 μm and maximally 200 μm. In this range, good protection of the metal strip 1 against damage exists at a reasonable material expenditure for the plastic layer 3.

For the sake of good order, it should be pointed out, in conclusion, that for a better understanding of the structure, some elements were shown not to scale and/or larger and/or smaller.

### REFERENCE SYMBOL LISTING

1 metal strip
2 core
3 protective layer
4 protective layer
5 core
6 core
7 core
8 roller
9 roller
10 spray device

1. A method for provision of a metal strip (1) with a protection for transportation, wherein the metal strip (1), in a Step i), is coated with a plastic, and, in a Step ii), is wound up in multiple layers, wherein in Step i), the plastic is applied to the metal strip in liquid or paste form, and solidified, characterized in that in Step i), a strippable varnish based on an organic solvent is applied as the plastic.

2. The method according to claim 1, wherein the strippable varnish applied in Step i) is dried, and in a subsequent step, it is varnished again with at least one layer of a cover varnish, in particular one based on an organic solvent.

3. The method according to claim 1, wherein the strippable varnish and the cover varnish are sprayed on.

4. The method according to claim 1, wherein the strippable varnish applied in Step i) has a solvent proportion between 30 and 60 percent by weight, wherein toluene and/or acetone, in particular, is/are used as the solvent.

5. The method according to claim 1, wherein the strippable varnish applied in Step i) has a plastic proportion between 30 and 60 percent by weight.

6. A metal strip, wherein it is provided with a protection for transportation in accordance with the method according to claim 1, and has a solvent-based strippable varnish that adheres directly to the metal strip (1).

7. The metal strip according to claim 6, wherein the metal strip has a surface polished to a high shine, which is coated with the strippable varnish over its full area.

8. The metal strip according to claim 7, wherein the strippable varnish has a layer thickness between 50 μm and 100 μm.

9. The metal strip according to claim 6 or 7, wherein it has at least one layer composed of a cover varnish, applied directly to the strippable varnish, wherein a total thickness of a protective layer (3, 4) comprising strippable varnish and cover varnish amounts to between 100 μm and 200 μm.

10. (canceled)
